(19) United States
(12) Patent Application Publication
(10) Pub. No.: US 2008/0292222 A1
(43) Pub. Date: Nov. 27, 2008

(54) DISPOSAL BAG HAVING EMBOSSED TIE FLAPS

(75) Inventor: Charles B. Snoreck, Chicago Ridge, IL (US)

Correspondence Address: THE CLOROX COMPANY, P.O. BOX 24305, OAKLAND, CA, 94623-1305, US

(73) Assignee: The Glad Products Company, Oakland, CA (US)

(21) Appl. No.: 12/119,365

(22) Filed: May 12, 2008

Related U.S. Application Data
(60) Provisional application No. 60/939,136, filed on May 21, 2007.

(51) Int. Cl. B31B 49/04; B29C 47/88; B29C 47/00; B65D 33/16; B29C 49/04

(52) U.S. Cl. 383/77; 264/563; 493/227; 493/194; 493/231

(57) ABSTRACT

Provided is a tie bag having at least two tie flaps. The tie bag includes a first sidewall and a second sidewall opposing the first sidewall. The first and second sidewalls are coupled by sealing together three of four corresponding peripheral edges of the sidewalls. The fourth peripheral edge of each of the first and second sidewalls remains unsealed to define an opening in the tie bag. The tie flaps are integral with and extend from the opening of the tie bag and are adapted for tying one to another to close the tie bag and to form a handle for the tie bag. Each of the tie flaps includes gripping features embossed on at least one surface of the tie flaps. The tie bag may be formed from a tube of thermoplastic material.

### RELATED APPLICATION

This application claims priority to U.S. Provisional Application No. 60/939,136, filed on May 21, 2007, which is hereby incorporated by reference in its entirety.

### BACKGROUND OF THE INVENTION

1. Field of the Invention

The present invention pertains to bags used most commonly for the storage and disposal of debris and other ubiquitous waste materials and more particularly to disposal tie bags having tie flaps

2. Description of Related Art

The manufacture and use of rectangular shaped thermoplastic storage and disposal bags is well known in the art. One of the bothersome problems with the use of plain rectangular shaped storage bags is the inconvenience involved in trying to tie the bag closed. Several disposal bag brands use twistable metal wire ties, which are packaged separately along with the bags. These metal wire ties are unwieldy to use and, as a separate item, are often lost or misplaced from the bags.

A convenient user feature developed in the prior art is integral tie flaps on the bag. These tie flaps typically comprise a curved, cut-out portion at the opening of the open top of the bag. As built-in features, the tie flaps are grasped and knotted to seal the bag opening. Hence, bags that included integral tie flaps are referred to in the trade as “tie bags”. Representatives of such “tie bags” are those illustrated in U.S. Pat. Nos. 4,890,736, 5,041,317, 5,246,110, 5,683,340, 5,611,627, 5,709,641, and 6,565,794, which are characterized as having two or more tie flaps. The tie flaps are used as a closure means by tying the tie flaps together to close off the opening of the tie bag open top after the tie bag is filled with it the contents.

It has been determined, however, that the tie flaps of prior art tie bags, are often difficult to grasp and manipulate especially if the tie flaps are contaminated with slippery trash contamination such as oil or grease or moist organic contaminants. A tie bag in accordance with the principles of the present invention overcomes these difficulties. The tie flaps are characterized as being more easily and firmly graspable over tie flaps of current tie bags. These improved tie flaps provide ease of handling, improved strength and improved ease of tying over prior art tie bags.

### SUMMARY OF THE INVENTION

The ease of tying and the strength of joined tie flaps of a tie bag are improved by texturizing at least one surface of each of the tie flaps of the tie bag. Embossing gripping features on the tie flaps is one example of texturizing the tie flaps. In this embodiment, the embossed tie flaps further have a film thickness greater than the film thickness in the body of the bag used for holding its contents. Texturizing the tie flaps may be accomplished through various means well known to those of ordinary skill in the art such as, for example, embossing by mating plates rolls or drums, thermoforming, high pressure hydraulic forming, or casting. Texturizing may be done during manufacture of the tie bag or may be done after the tie bag is otherwise fully formed.

Typically, the tie bags are formed from a web of flexible, plastic material that is sized and cut into individual bags having geometrically shaped tie flaps for each tie bag unit. The tie flaps of the tie bags may be cut in curvilinear shapes and, when viewed in a flattened configuration, may be overlapping or in a skewed non-overlapping arrangement as shown in U.S. Pat. Nos. 4,890,736, 5,041,317, 5,246,110, 5,683,340, 5, 611,627, 5,709,641, and, 6,565,794.

Tie bags having tie flaps with gripping features may be made in a single bag process. Separate, opposing, generally rectangular sidewalls of the tie bag, made from plastic film and each having four peripheral edges, may be coupled by first overlapping and then aligning the sidewalls and then coupling together, typically by heat sealing, three of four corresponding peripheral edges of the sidewalls. Peripheral edges are said to be corresponding when one peripheral edge is meant to align and overlap with another peripheral edge during manufacturing of the tie bags of the present invention. The corresponding fourth peripheral edges of the opposing sidewalls remain unsealed to define an opening in the open top of the tie bag. The fourth peripheral edges forming the opening of the bag are cut or slit in the geometric shape of the tie flaps before or after the tie bag is formed. In this embodiment, texturizing the gripping features on the tie flaps may be accomplished by embossing before or after the forming of the bag and before or after the cutting of the tie flaps. In one embodiment, the tie flap geometric shape profile is curvilinear, e.g., sinusoidal or serpentine. In other embodiments, the tie flap profile is rectilinear.

In an alternative single bag process, a film of plastic material is folded over to overlap and align thus integrally coupling one set of corresponding peripheral edges of the tie bag sidewalls at the fold. The fold also forms the closed bottom of the tie bag. The overlapped and aligned film of plastic material is then coupled together along two of the remaining three overlapping peripheral edges of the tie bag sidewall by heat sealing. The remaining uncoupled peripheral edges of the tie bag sidewalls define the tie bag opening in the open top of the tie bag. The tie flaps are cut and the gripping features on the tie flaps are formed before or after tie bag formation as describe.

Alternatively, tie bags having tie flaps with embossed gripping features may be conveniently made by a continuous multi-bag process in which the tie bags are manufactured from a continuous folded-over single web or overlapping double web of a polyethylene or other thermoplastic film. By heat sealing or otherwise coupling portions of the folded-over single web or overlapping double web of plastic film the coupled corresponding peripheral edges of the multiple tie bags are coupled. The tie bags are then singulated by cutting individual bags from the continuous web. The tie flaps may be cut and the gripping features on the tie flaps may be embossed before or after the tie bags are formed.

In a continuous multi-bag process in accordance with the principles of the present invention, the multiple tie bags having tie flaps with gripping features are “blow formed” by the blown film extrusion method. In the blown film extrusion method, a continuous moving film tube of molten plastic melt is extruded from an annular die, and then stretched and expanded to a larger diameter and a reduced radial thickness by the drawing action of overhead nip rollers and internal pressure. Blowers are used to provide internal air pressure within the film tube that is utilized to control the size and thickness of the film tube. Further, air is also trained on the outside of the film tube as a cooling medium that absorbs heat from the molten plastic melt and speeds up the change in state from a molten plastic melt back to a solid plastic film. After solidification through cooling of the plastic melt forming the film tube, the film tube is collapsed into a flat double web and rolled into rolls for further processing.

The tie flaps of the tie bags of the present invention are characterized as being suitable for tying and have gripping features embossed to form a pattern imposed on one or both surfaces of the tie flaps. The gripping features form a roughened surface on the tie flaps relative to the smooth surface of the remaining portion of the tie bag sidewalls. These embossed gripping features forming the pattern on the surface of the tie flaps provide ease of bag handling, improved tie flap strength and improved ease of tie flap grasping and tying over current tie bags.

Thus, provided is a tie bag in accordance with the principle of the present invention that includes a first sidewall having four peripheral edges and a second sidewall opposing the first sidewall and having four corresponding peripheral edges. Three of the four peripheral edges of the first sidewall are coupled along a corresponding one of three of the four peripheral edges of the second sidewall with the corresponding fourth peripheral edges of the first and second sidewalls remaining unsealed to define an opening in the open top of the tie bag. Corresponding coupled peripheral edges may be coupled by heat sealing or by an integral fold that overlaps the peripheral edges of the sidewalls. The tie bag further includes at least two tie flaps coupled to the tie bag and extending from the fourth peripheral edges forming the opening of the tie bag. At least one tie flap from the at least two tie flaps extends from each of the first and second sidewalls. The tie flaps are adapted for tying one to another and each of the tie flaps includes gripping features on at least one surface.

### BRIEF DESCRIPTION OF THE DRAWINGS

Reference will now be made to the drawings wherein like numerals refer to like parts throughout. When considered in conjunction with the subsequent detailed description, a complete understanding of the present invention may be obtained by reference to the accompanying drawings, in which:

FIG. 1 shows a schematic sectional, side view of a blow molding extruder used to produce a blow-formed continuous film tube of polyethylene or other thermoplastic material;

FIG. 2 shows a perspective view of a portion of the film tube formed in the extruder of FIG. 1;

FIG. 3 shows a perspective view of the film tube of FIG. 2 slit to form embossed tie taps in accordance with the principles of the present invention;

FIG. 4A shows a tie bag in a flat overlapped configuration having four tie flaps made up of two pairs of tie flaps;

FIG. 4B shows multiple tie bags in a flat overlapped configuration formed from a continuous folded-over single-ply web of plastic material;

FIG. 5 shows an enlarged view of the encircled region designated by reference numeral 5 in FIG. 4A;

FIG. 6 shows a perspective side view of the tie bag of FIG. 4A in an upright configuration, after opening and loading of the tie bag; and

FIG. 7 shows a plan view of the tie bag of FIG. 6 with four embossed tie flaps cross-tied to form a handle by which the tie bag can be lifted.

### DETAILED DESCRIPTION OF THE INVENTION

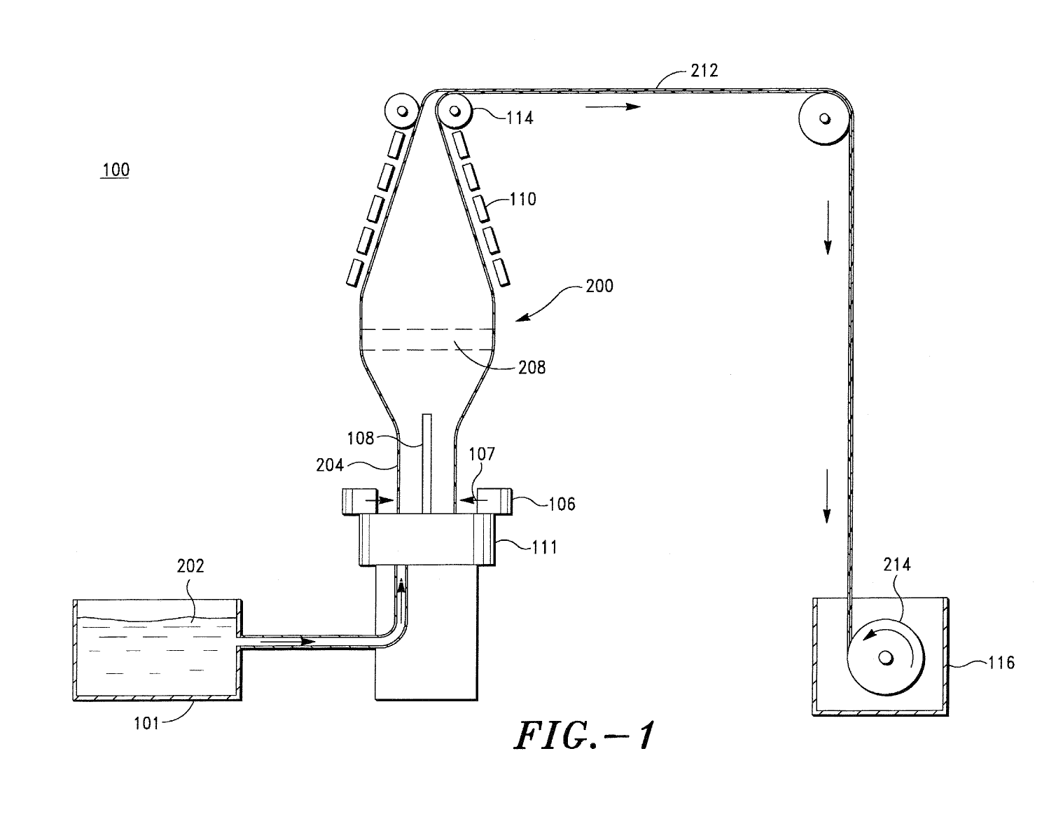

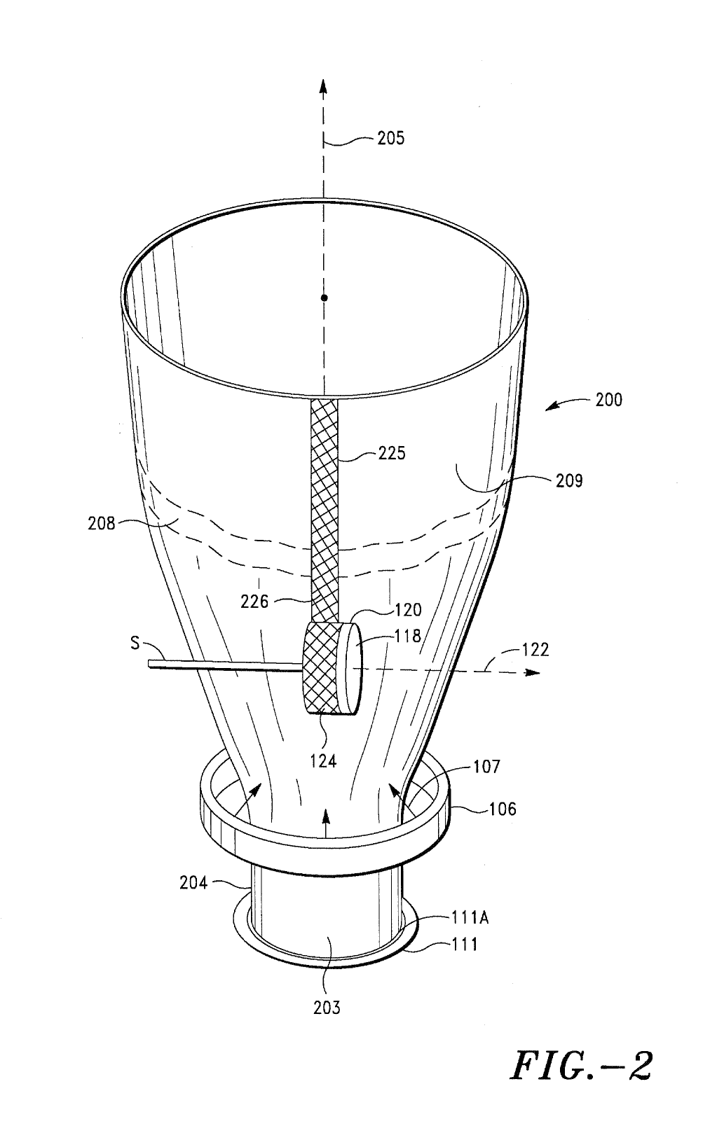

FIG. 1 shows a schematic sectional, side view of a blow molding extruder 100 used to produce a blow-formed continuous film tube 200 of polyethylene or other thermoplastic material. FIG. 2 shows a perspective view of a portion of the film tube 200 formed in the extruder 100 of FIG. Processes for the manufacture of blown film tubes are generally known. Blown film extrusion processes are described, for example, in U.S. Pat. Nos. 2,409,521, 2,476,140, 2,634,459, 3,750,948, 4,997,616, 5,213,725, and 5,700,489.

Referring to FIGS. 1 and 2 together, in a blow molding processes, molten plastic melt 202 is first formed in a melt tank 101 of an extruder 100 (FIG. 1). The plastic melt 202 is subsequently compressed in an annular blowing head 111 that has a ring-shaped output gap 111A, usually referred to as a “die”, through which the plastic melt 202 flows.

In the bag forming process, the plastic melt 202 is extruded from the output gap 111A (FIG. 2) in the blowing head 111 to form an amorphous bubble, some times referred to as a tubular stalk 204, that is thereafter expanded to fully form a continuous cylindrically shaped film tube 200 exiting and moving away from the blowing head 111. As shown in FIG. 1, film tube 200 includes a tube central axis 205 along the length of film tube 200 and a tube outside surface 209 at the outside of the cylinder forming film tube 200. By blowing air into the inside of the moving tubular stalk 204 through an in-bag pressurizing pipe 108 (FIG. 1) within the interior of stalk 204, a pressure is produce inside the tubular stalk 204 that is higher than the external pressure outside the tubular stalk 204. The higher inside pressure causes the moving tubular stalk 204 to expand into the fully formed continuous cylindrical web of the film tube 200.

As shown, an annular shaped air ring cooler 106, circumscribing stalk 204, blows gaseous cooling air, as indicated by arrows 107 in FIG. 2, toward the stalk outside surface 203 of stalk 204 to rapidly cool the moving molten plastic melt 202 forming tubular stalk 204. By regulating the temperature of the cooling air 107 exiting air ring cooler 106 and other manufacturing parameters, a frost line region 208 is established circumferentially at a static location on the extruder 100. The frost line region 208 is the location beyond the air ring cooler 106 where the molten plastic melt 202 forming the film tube 200 solidifies through cooling as film tube 200 moves away from air ring cooler 106 along the direction of tube central axis 205. At this frost line region 208, film tube 200 no longer expands as it moves away from air ring cooler 106 since the molten plastic melt 202 forming film tube 200 has now completely solidified.

Between the position of air ring cooler 106 and the static position of the frost line region 208 of the moving film tube 200 is a rotable tangent drum 118 (FIG. 2). Tangent drum 118 is generally configured as a cylinder having drum central axis 122 along the length of tangent drum 118 and a drum outside surface 120 at the outside surface of the cylinder forming tangent drum 118. Tangent drum 118 is oriented such that the drum central axis 122 of tangent drum 118 is generally perpendicular to the tube central axis 205 of film tube 200. Further, tangent drum 118 is positioned such that projections 124 on the drum outside surface 120 abuttingly contact the tube outside surface 209 of film tube 200. Said another way tube outside surface 209 is substantially tangent to drum outside surface 120 of tangent drum 118. Rotable tangent drum 118 is rotated about a shaft S located along drum central axis 122 such that the circumferential speed and direction of rotating drum outside surface 120 matches the linear speed and direction of movement of film tube 200 as it moves away from air ring cooler 106. By this means, film tube 200 may be made to pass over the drum outside surface 120 of rotable tangent drum 118 without tearing or ripping of film tube 200. In another embodiment, the moving drum outside surface 120 of tangent drum 118 is rotated about shaft S by its contact with the moving web of film tube 200 without the need for outside power to rotate tangent drum 118.

As noted, the drum outside surface 120 of rotable tangent drum 118 includes one or more circumferentially spaced apart raised ridge or rib-like projections 124 extending outwardly from the drum outside surface 120. Projections 124 are typically small relative to the diameter of tangent drum 118. In another embodiment, rotable tangent drum 118 is configured as a squirrel-cage type rotable drum formed from a wire mesh material, the wire mesh material features themselves forming the projections 124. In operation, after each portion of the moving fill tube 200 exits the air ring cooler 106 and while still in a softened, not completely solidified form, a part or strip segment 225 of each portion of moving film tube 200 contacts projections 124 as it passes over the projections 124 of tangent drum 118. As the strip segment 225 of each portion of moving film tube 200 contacts projections 124, the still soft strip segment 225 of plastic melt 202 fully sets and solidifies by conduction of heat from the plastic melt 202 to the projections 124 of the tangent drum 118. The tangent drum 118 may be chilled by various well know techniques to control the full set and solidification of the soft plastic melt 202 of strip segment 225 that contacts the projections 124 of tangent drum 118.

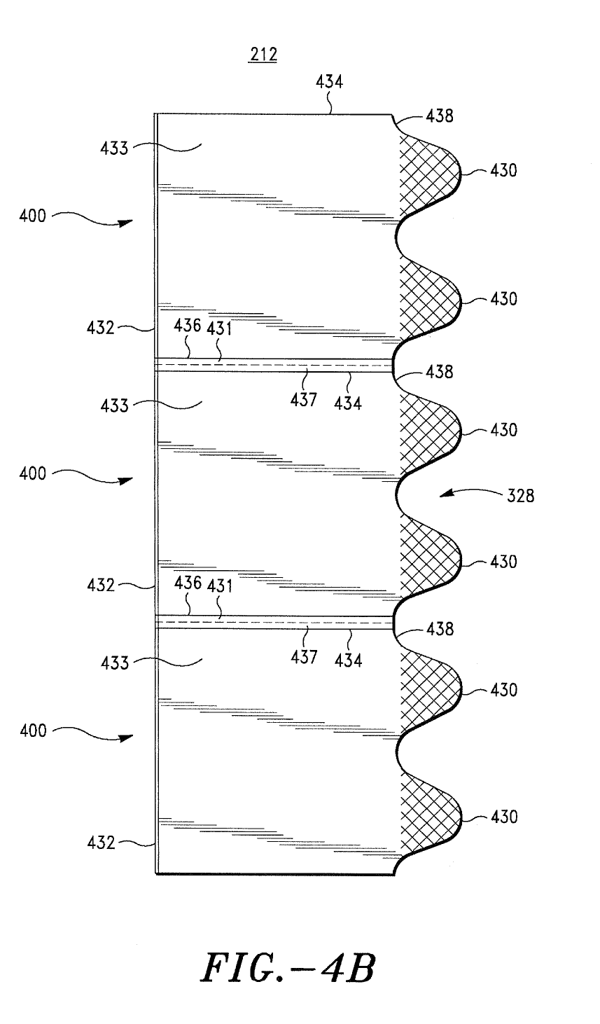

The part of plastic melt 202 of the strip segment 225 that contacts the projections 124 sets and solidifies before the frost line region 208 where the remaining portions of film tube 200 set and solidify. Further, when those parts of film tube 200 that contact projections 224 solidify, they cease film-thinning expansion while the remaining portions of the still softened plastic melt 202, which have not yet arrived at the frost line region 208 of film tube 200, continue radially thinning expansion. Thus, these projection contacting parts of strip segment 225 form one or more thickened raised gripping features 226 (See also FIG. 5) on the strip segment 225 of film tube 200 that passes tangentially over the tangent drum 118. In the embodiment shown, the gripping features 226 trace a raised diamond shaped pattern within the strip segment 225 along the length of the film tube 200.

After formation of the gripping features 226, the continuous web of film tube 200 is collapsed at a collapsing frame 110 (FIG. 1) and subsequently formed into a flat web 212 (FIG. 1) at nip rollers 114 (FIG. 1). The flat web 212 is wound into a film tube roll 214 at a winder 116. The two flattened film layers of finished web 212 of film tube 200 are not, at this point in the process, separated but rather are wound as two overlapping film layers into two-ply tube rolls 214.

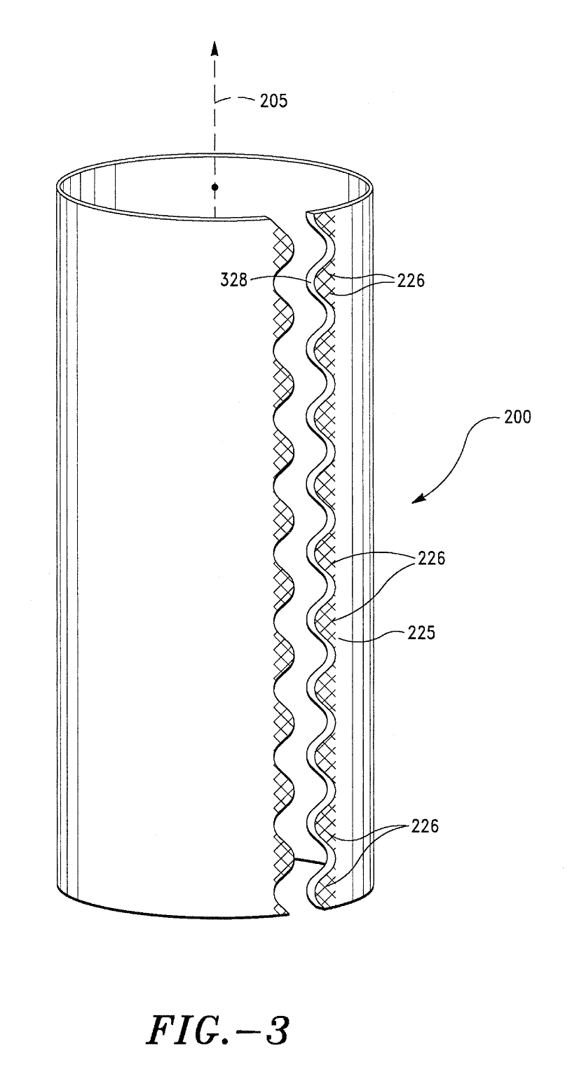

FIG. 3 shows a perspective view of a portion of the film tube 200 formed in the extruder 100 of FIG. 1 at a further stage of processing. Referring to FIGS. 1 and 3 together, in one embodiment film tube 200 has been unrolled from tube rolls 214 and slit axially in the direction of tube central axis 205 along the length of film tube 200 to form a single sheet of plastic film. As shown in FIG. 3, in one embodiment the film tube 200 has been slit in the profile of a sinusoidal wave slit 328. Further, as shown in FIG. 3, a slit 328 in film tube 200 is made at the strip segment 225 of film tube 200 that passed tangentially over the drum outside surface 120 of tangent drum 118 (FIG. 2) and which contains the raised gripping features 226 formed as described above. The profile of slit 328 in film tube 200 may take other shape profiles beside sinusoidal, such as, for example, wave-shaped, arc-like, serpentine, zigzag, saw-toothed, and square-wave. Various well know means may by used to axially slit film tube 200. Once slit, film tube 200 is further processed to form tie bags in accordance with the principle of the present invention.

In another embodiment, film tube 200 is slit axially prior to winding into tube rolls 214 After formation of the gripping features 226, the continuous web of slit film tube 200 is wound into a film tube roll 214 at a winder 116. The slit single film layer of the finished web of film tube 200 is wound as a single-ply web into tube rolls 214 for later processing.

In yet another embodiment, multiple tangent drums 118 (FIG. 2), spaced apart circumferentially about film tube 200, form multiple strip segments 225 having gripping features 226 on film tube 200 as film tube 200 passes tangentially over respective drum outside surfaces 120 of multiple tangent drums 118. After formation of multiple strip segments 225, each strip segment 225 is slit along a respective slit 328 to form multiple flat webs 212 that are individually wound into multiple individual single-ply film tube rolls 214 at a multiple winders 116.

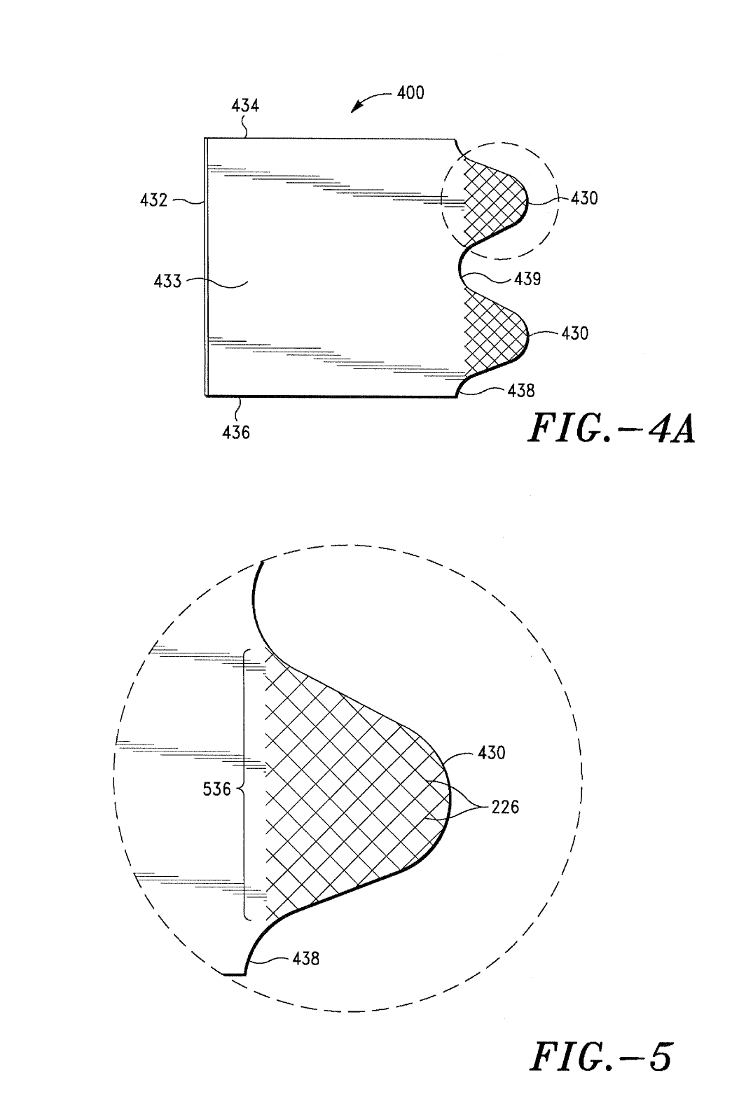

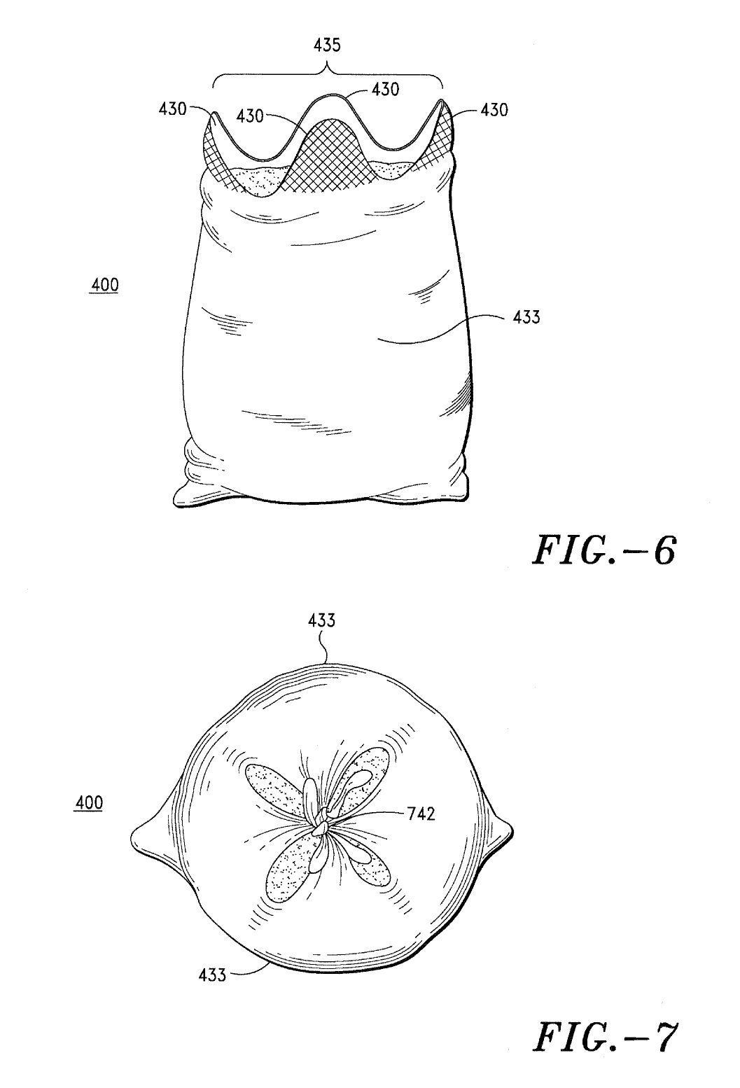

FIG. 4A shows a tie bag 400 in a flat overlapped configuration having tie flaps 430 extending upwardly from the peripheral edges forming the opening 435 of open top of the tie bag 400. At least one tie flap 430 extends from each of the first and second sidewalls. Referring to FIG. 4A, in a single bag process, a tie bag 400 includes opposing sidewalls 433 formed from two individual, generally rectangular film layers of plastic material. In the flat overlapped configuration shown, only a first sidewall and a first pair of tie flaps 430 overlying, respectively, a second sidewall and a second pair of tie flaps 430 is shown in FIG. 4A. (See also FIG. 6 with bag 400 in an expanded configuration.) Each of the first and second sidewalls 433 has four peripheral edges 432, 434, 436, and 438. The first and second sidewalls 433 are coupled at three of their respective corresponding peripheral edges 432, 434 and 436. Peripheral edges are said to be corresponding when one peripheral edge is meant to align and overlap with another peripheral edge. The remaining fourth peripheral edges 438 of each of the first and second sidewalls 433 are not coupled and together define an opening 435 (FIG. 6) in the open top of the tie bag 400.

The tie flaps 430 may comprise curved or other geometrically shaped portions of the film making up the bag sidewalls 433. The geometric shape profile of the tie flaps 430 may be curvilinear, e.g., such as may be formed in a sinusoidal cut along the fourth peripheral edges 438 forming the opening 435 of the open top of the tie bag 400. Other shape profiles are possible such as, wave-shaped, serpentine, arc-like, zigzag, saw-toothed, and square-wave. The tie flaps 430 may be overlapping as shown or may be in a skewed non-overlapping arrangement of the individual bag units as shown in the above referenced U.S. Pat. No. 6,565,794.

Advantageously, in another single bag embodiment, bag 400 is formed from a single film layer of finished web of blow formed film tube 200 that has been slit as described above, singulated by two cuts transverse to the extrusion direction, and folded over to couple a pair of first corresponding peripheral edges 432 that form and define a bag closed bottom. The fold also places the single web of slit film tube 200 into the flat overlapping configuration shown in FIG. 4A.

The tie flaps 430 are adapted for tying one to another. The tie flaps 430 are shown as integral with and form a portion of the sidewalls 433 of the tie bag 400 with a cutout portion 439 between adjacent tie flaps 430. In the blown tube method described above, the tie flaps 430 are defined by the slit 328 (FIG. 3) when film tube 200 is slit as described above.

As noted above in connection with the embodiment shown in FIG. 4A, tie bag 400 has four tie flaps 430 with each of the first and second sidewalls 433 having two tie flaps 430. Again, in the flattened configuration show, only the two tie flaps 430 integral with the first sidewall 433 are shown in FIG. 4A. Alternatively, the tie bag 400 may have four tie flaps extending from each of the first and second sidewalls 433 as disclosed in U.S. Pat. Nos. 5,246,110 and 5,611,627, or, as would be readily apparent to those of skill in the art, tie bag 400 may have four or more tie flaps 430 extending from each of the first and second sidewalls 433. Each of the tie flaps 430 is adapted for tying, one to another, to form a knot that closes opening 435 and seals the open top of tie bag 400. The knot formed by tied tie flaps 430 further provides a convenient “handle” to lift a filled tie bag 400.

Representative tie bags 400, which may be improved by use of the present invention, include, but are not limited to those disclosed in U.S. Pat. Nos. 4,890,736, 5,041,317, 5,246,110, 5,683,340, 5,611,627, 5,709,641, and 6,565,794. As described in detail in U.S. Pat. No. 6,565,794, in one embodiment, the thickness of the tie flaps 430 is greater than the thickness of the sidewalls 433 of the tie bag 400.

FIG. 5 shows a close-up portion of the tie bag 400 of FIG. 4A that shows a tie flap 430 in detail. Referring to FIGS. 4A and 5, together, the tie flap 430 is texturized and includes one or more gripping features 226 embossed on at least one surface of the tie flap 430. In one embodiment, the gripping features 226 are configured as raised ridges or rib-like structures above the surface of the tie flap 430. In the blown film method, the texturizing of the tie flaps is accomplished by embossing gripping features 226 on tie flaps 430 by the embossing method described using the tangent drum 118 of FIG. 2. In the embodiment shown, the gripping features 226 traces a diamond shaped pattern 540 across the tie flap 430 surface. The gripping features 226 may be different from the straight-line features forming the diamond shaped pattern 540 shown in FIG. 5. For example, gripping features 226 having profiles such as zigzag, stepped, saw-toothed, arc like, serpentine or other shapes are possible. Other patterns may be traced by the gripping features 226, e.g. crosshatched and other repeating curvilinear or rectilinear traces. The plurality of gripping features 226, embossed as a pattern on the tie flaps 430, make tying of a tie flap 430 to another tie flap 430 easier for a user of tie bag 400.

Further, texturizing by embossing of a plurality of gripping features 226 onto tie flap 430 may be combined with the increased thickness of the tie flap 430, when present, and as described below and in detail in the above referenced U.S. Pat. No. 6,565,794, permits the user to more easily open the tie bag 400 by grasping the tie flaps 430 more readily and firmly. The tie flaps 430 may be integral extensions of the two bag sidewalls 433 of tie bag 400 and their separation by a user opens the tie bag 400. Pulling apart the embossed tie flaps 430 with a secure grip more easily permits separation of even thin thermoplastic film materials that may exhibit static cling.

FIG. 4B shows multiple tie bags 400 in a flat overlapped configuration formed from a continuous, folded-over, single-ply web of plastic material formed from a film tube 200 manufactured by the blow formed method described above with reference to FIGS. 1, 2 and 3. In the flat, overlapped configuration shown, only first sidewalls and their tie flaps are shown. Tie flaps 430 have been defined and integrally formed on each bag 400 by the slit 328. (See also FIG. 3). A bottom fold forms a double-ply web and couples pairs of first corresponding peripheral edges 432 of the first and second sidewalls 433 of the tie bags 400 to form bag closed bottoms. Heat seals 431, transverse to the extrusion direction of film tube 200, couple pairs of second and pairs of third corresponding peripheral edges 434 and 436 of the sidewalls 433 of the tie bags 400 to form closed bag side edges. Within each heat seal 431 is a perforation cut 437 along the heat seals 431. The perforation cuts 437 provide for singulation of an individual tie bag 400 by tearing along the perforation cuts 437 between abutting tie bags 400. Pairs of fourth corresponding peripheral edges 438, each having at least one tie flap 430, remain uncoupled and together define the tie bag openings 435 (FIG. 6) of the open tops of the tie bags 400. The double-ply web may be conveniently placed on a tie bag roll (not shown) for later singulation by a user of tie bags 400. Alternately, multiple tie bags 400 may be singulated by cutting through the continuous double-ply web of plastic material along the heat seals 431 common to abutting tie bags 400.

FIG. 6 shows a perspective side view of the tie bag 400 of FIG. 4A or 4B in an upright configuration, after opening and loading of the tie bag 400. FIG. 7 shows a plan view of the tie bag 400 of FIG. 6 with the four embossed tie flaps 430 cross-tied to form a handle 742 by which the tie bag can be lifted. Referring to FIGS. 6 and 7 together, after opening and loading the tie bag 400, the tie flaps 430 are pulled toward each other to close-off the opening 435 of the tie bag 400 and are then tied together to effect closure of the tie bag 400. The embossed tie flaps 430 having gripping features 226 (FIG. 5) provide a strong, more graspable handle 742 when tie bag 400 is tied at its tie flaps 430. The user need tie only a single pair of tie flaps 430 to close the opening 435 of the open top of tie bag 400 or may tie two pair of tie flaps 430 depending on the weight, elasticity or other characteristics of the material contained in the tie bag 400.

Depending on the number of tie flaps 430 selected for tie bag 400, the tie flap length may be varied from about 4 inches to about 6 inches. When a tie bag 400 has four tie flaps 430, the tie flap length is typically about 4 to 5 inches for 30-gallon tie bag sizes to provide sufficient length to easily grasp the tie flap 430 for tying. For such a tie flap 430, the width of the sinusoidal shaped tie flap is typically be about 15 inches if four tie flaps are used at the opening 435 of the bag. However, these lengths and widths for the tie flaps 430 are intended as non-limiting examples only. As will be well appreciated by a person of ordinary skill in the art, tie flap length and width may be adjusted as needed for a particular application, the number of tie flaps 430 and selected use of the tie bag 400.

Methods for texturizing the tie flaps 430 include, but are not limited to, embossing by mating plates or rolls, thermoforming, high pressure hydraulic forming, casting, or the tangent wheel process described in detail above. While the entire portion of the tie flaps 430 may be subjected to a forming operation, the present invention may also be practiced by subjecting to formation only a portion thereof.

In another embodiment, the tie flap 430 may be made thicker and stronger by reinforcing the tie flap 430 by adding another film layer of plastic by coextrusion or other means so that the tie flaps 430 have a greater thickness than the remainder of the tie bag 400. The gripping features 226 may be formed more prominently in these thickened tie flaps 226 to further enhance the gripping characteristics of the gripping features 226. For example, the first film layer may be a high-density polyethylene (HDPE) and the second film layer may be an ultra-low density polyethylene (LDPE) having greater tears resistance. In this manner, the tie flap 430 can be formed from thermoplastic material having better resistance to tearing and improved embossing characteristics.

In another embodiment, with increased localized air cooling by profiling the air ring cooler 106 (FIGS. 1 and 2), the strip segment 225 film tube 200 may be thickened. Increasing the size of the opening of the air ring cooler 106 at the areas of film tube 200 where the strip segment 225 containing tie flaps 430 is located localizes increased cooling at film tube 200 at these strip segment areas. As described above, earlier cooling causes earlier solidification of the plastic melt with concomitant increased thickness of the film tube area where the tie features are to be formed.

The currently plastics materials for plastic tie bags of the present invention are the various forms of polyethylene, including high density and the various forms of low density polyethylene, polypropylene and blend of these and other plastic material capable of being formed into films having a thickness of between about 0.5 mil and 3 mil. Any thermoplastic material suitable for use in making films may be used to make the present invention.

While the invention is described herein in connection with certain exemplar embodiments, there is no intent to limit the present invention to those embodiments. On the contrary, it is recognized that various changes and modifications to the described embodiments will be apparent to those skilled in the art upon reading the foregoing description, and that such changes and modifications may be made without departing from the spirit and scope of the present invention. Skilled artisans may employ such variations as appropriate, and the invention may be practiced otherwise than as specifically described herein. Accordingly, the intent is to cover all alternatives, modifications, and equivalents included within the spirit and scope of the invention. Moreover, any combination of the above-described elements in all possible variations thereof is encompassed by the invention unless otherwise indicated herein or otherwise clearly contradicted by context.

1. A method for manufacturing a bag having a closed bottom and sides and an open top, the open top having integral tie flaps extending therefrom comprising:
extruding plastic melt through a blown-film extruder to form a blow-formed continuous film tube; and
texturizing a strip portion of the film tube where the tie flaps are to be formed to provide a gripping feature to the tie flaps.

2. The method of claim 1 wherein the texturizing includes contacting a surface of said film tube below a frost line thereof against a rotable tangent drum having a textured surface.

3. The method of claim 2 wherein the texturizing further includes providing localized cooling to formed additional thickened regions to said film as desired.

4. The method of claim 1 further comprising:
slitting said film tube along said strip segment along a geometric profile to form at least two tie flaps of said tie bag.

5. The method claim 4 wherein said geometric profile is selected from the group of geometric profiles consisting of sinusoidal, wave-shaped, arc-like, serpentine, zigzag, saw-toothed, and square-wave.

6. The method of claim 4 wherein said tie bag comprises:
a first sidewall and a second sidewall opposing said first sidewall, each of said first and said second sidewall having four peripheral edges; and
wherein said method of claim 1 further comprises:
coupling three of said four peripheral edges of side first sidewall with a corresponding one of three peripheral edges of said second sidewall, said fourth peripheral edges of each of said first and said second sidewall being uncoupled and together defining an opening in said tie bag, each of said first and said second sidewall having at least one tie flap extending from said fourth peripheral edge of said first and said second sidewall.

7. The method of claim 6 wherein said coupling comprises heat sealing said corresponding peripheral edges of said first and said second sidewalls.

8. The method of claim 6 wherein said coupling comprises an integral fold that overlaps said corresponding peripheral edges of said first and said second sidewalls.

9. The method of claim 8 further comprising perforating said double-ply web along said heat seals.

10. The method of claim 9 further comprising rolling said double-ply web into tie bag rolls.

11. The method of claim 8 further comprising cutting said double-ply web along said heat seals.

12. The method of claim 8 wherein the thickness of said tie flaps is greater than the thickness of said first and said second sidewalls of said tie bag.

13. A method of manufacturing a tie bag having a first sidewall having four peripheral edges and a second sidewall opposing said first sidewall and having four peripheral edges, each of said first and said second sidewalls having at least one integral tie flap with gripping features and extending from said fourth peripheral edge, said method comprising:
extruding plastic melt through a ring-shaped output gap of a die to form a tubular stalk;
cooling said tubular stalk with cooling air from an air ring cooler circumscribing said tubular stalk;
pressurizing the interior of said tubular stalk such that the pressure inside said tubular stalk is higher than the pressure outside said tubular stalk;
expanding said tubular stalk into a cylindrically shaped moving film tube by said pressurizing;
establishing a static frost line region beyond said air ring cooler on said moving film tube;
between said air ring cooler and said frost line region, contacting a portion of the surface of said film tube with a tangent drum having projections;
further cooling a portion of said film tube along a strip segment of said film tube by contact of said strip segment of said film tube with said projections of said tangent drum;
embossing gripping features on said film tube along said strip segment by said further cooling;
slitting said film tube along said strip segment of said film tube in a geometric profile;
forming said tie flaps by said slitting; and
coupling three of said four peripheral edges of side first sidewall with a corresponding one of said three peripheral edges of said second sidewall, said fourth peripheral edge of each of said first and said second sidewalls being uncoupled.

14. The method of claim 13 further comprising providing increased cooling to said film tube at said strip segment during said extruding to thicken said film tube along said strip segment.

15. The method of claim 14 wherein said providing increased cooling comprises profiling said air ring cooler.

16. The method of claim 13:
wherein said tangent drum is generally configured as a cylinder having a drum central axis along the length of said tangent drum;
wherein said tangent drum includes projections extending outwardly from said tangent drum;
wherein said tangent drum is oriented such that said drum central axis of said tangent drum is generally perpendicular to the film tube central axis of said film tube: and
wherein said tangent drum is positioned such that the tube outside surface of said film tube abuttingly contacts said projections of said tangent drum.

17. The method of claim 16 wherein said projections comprises wire mesh material.

18. A method for manufacturing multiple tie bags comprising:
extruding a film tube having a strip segment containing embossed gripping features;
axially slitting said film tube along said strip segment to form a single-ply web and to define tie flaps of said tie bag;
folding-over and aligning said single web to form a double-ply web and to couple pairs of first corresponding peripheral edges of first sidewalls and second sidewalls of said tie bags to form bag bottoms; and
coupling pairs of second and a pairs of third corresponding peripheral edges of said first sidewalls and said second sidewalls of said tie bags with heat seals transverse to the extrusion direction of said film tube to form bag sides.

19. A tie bag comprising:
a first sidewall having four peripheral edges;
a second sidewall opposing said first sidewall and having four peripheral edges;
wherein three of said four peripheral edges of said second sidewall are coupled along a corresponding one of three of said four peripheral edges of said first sidewall;
wherein the fourth peripheral edge of said first sidewall and the fourth peripheral edge of said second sidewall are not coupled and together define an opening;
at least two tie flaps coupled to said tie bag and extending from said opening;
wherein said at least two tie flaps are adapted for tying one to another; and
wherein said tie flaps comprise gripping features on at least one surface of each of said at least two tie flaps.

20. The tie bag according to claim 19 wherein at least one of said at least two tie flaps is integral with each of said first sidewall and said second sidewalls of said tie bag.

21. A tie bag according to claim 19 wherein geometric shape profile of said tie flaps is selected from the group of geometric shape profiles consisting of sinusoidal, wave-shaped, arc-like, serpentine, zigzag, saw-tooth, and square-wave.
